(19) United States
(12) Patent Application Publication
(10) Pub. No.: US 2009/0181664 A1
(43) Pub. Date: Jul. 16, 2009

(54) Method and apparatus for network managed radio frequency coverage and mobile distribution analysis using mobile location information

(76) Inventors: Eapen Kuruvilla, Plainfield, IL (US); Samuel Betrencourt, Issy les Moulineaux (FR)

Correspondence Address: FAY SHARPE/LUCENT, 1228 Euclid Avenue, 5th Floor, The Halle Building, Cleveland, OH, 44115-1843, US

(21) Appl. No.: 12/008,855

(22) Filed: Jan. 15, 2008

(51) Int. Cl. H04M 3/22

(52) U.S. Cl. 455/423; 455/67.11

(57) ABSTRACT

A system and method for identifying geographical areas which distribute poor radio frequency coverage is provided. The method includes measuring a radio frequency signal of a mobile unit in response to a trigger. The method continues with mapping the location data of the radio frequency signal which represents the positioning of the mobile unit at a given time. The method continues with recording the location data of the mobile unit and storing the location data in a database. The trigger, which prompts the radio frequency measurement, may be a timer expiring, a dropped call, or a mobile power increase signaling a weak signal. In any form, a post processing module may be configured in order to record, store and organize the location data into a report, such as a coverage map. Embodiments of this disclosure will display geographic areas that have poor radio frequency and allow for an administrator to identify trouble spots by a geographical region.

### BACKGROUND OF THE DISCLOSURE

This disclosure relates to a method for identifying areas that have poor signal strength coverage within a cell. More particularly, this disclosure relates to measuring radio frequency signals in response to a trigger where the signals identify the signal strength in the given cell area.

While this disclosure is particularly directed towards measuring signal strength in problem areas and will thus be described with particular reference thereto, it will be appreciated that this disclosure may have usefulness in other fields and applications. For example, this disclosure may be useful in a variety of telecommunication services where it is helpful to determine the strength of a Radio Frequency (RF) signal, including hot spots and dead spots.

By way of background, in order for a wireless network to function correctly, there needs to be continuous RF coverage. Inadequate RF coverage results in dropped calls and poor voice quality. Because service providers generally want to provide exceptional voice quality, it is important for service providers to identify areas with poor RF coverage. Service providers also want to identify areas of poor RF coverage areas in order to maximize efficiency when deciding where to place a new cell tower.

Currently, in the industry there are solutions that are designed to identify areas with poor RF coverage. One solution discussed in U.S. Pat. No. 6,459,695, describes a method and a system for identifying regions with RF coverage problems. Calls are monitored and the location of the mobile users are tracked by using the number of failed called attempts and dropped calls. The contents of U.S. Pat. No. 6,459,695 is hereby fully incorporated by reference. However, it should be noted that this solution only measures failed and dropped calls, whereas many calls have low quality of service and are not measured through this method.

Another method of measuring RF coverage is to perform a drive test. Drive tests include taking RF signal measurements at various geographic locations. However, this method requires technicians to physically visit various geographic locations in a wireless network. Furthermore, 100% coverage is impractical because a technician would generally not enter one's home. Furthermore, as a technician drives through various locations, the technician would stay on roads, and not enter shopping areas or other areas where people may be using their mobile units. Lastly, this systems does not reflect changing RF coverage due to construction and seasonal foliage unless the drive test is performed periodically. Due to these physical limitations and others, a drive test is insufficient.

Therefore, there is a need in the industry to provide a system and a method that continuously measures network coverage within a cell by measuring actual signal strength and not just the symptoms of failed signal strength. Furthermore, it would be advantageous for the system not to require a technician to physically visit the various locations. It would also be advantageous for the system and method to reflect changing RF coverages, due to the physical changing of the landscape in real time.

The present disclosure contemplates a new and improved system and method for resolving the above-referenced difficulties and others.

### SUMMARY OF THE DISCLOSURE

A method and apparatus for identifying areas within a cell with poor RF coverage. The network managed RF coverage analysis uses mobile location information functionality through its implementation. Two main software modules, the data collection module and the post processing module, are used in order to implement this procedure. The data collection module collects RF signal measurements and location information from multiple mobile phones in response to a trigger. A post processing module plots the RF coverage information on a map using data uploaded from the data collection module. A wireless provider may use this information in order to correct RF coverage problems.

In one aspect of the disclosure, a method for identifying problem areas within a cell comprises measuring a radio frequency signal of a mobile unit in response to a trigger. The method continues with mapping the precise location data of the radio frequency representing the positioning of the mobile unit at a given time, where the given time is related to the trigger. The method continues with recording the precise location data for the mobile unit and storing the precise location data in a database.

In accordance with another aspect of the present disclosure, the method includes that the trigger is a timer expiring.

In accordance with another aspect of the present disclosure, the method includes that the trigger is a mobile power increase.

In accordance with another aspect of the present disclosure, the method includes that the trigger is a weak signal.

In accordance with another aspect of the present disclosure, the method includes that the trigger is a dropped call.

In accordance with another aspect of the present disclosure, the method includes reestablishing a connection when the trigger is a dropped call.

In accordance with another aspect of the present disclosure, the method includes that mapping the precise location data is done via a mobile unit's global positioning system.

In accordance with another aspect of the present disclosure, the system includes that mapping the precise location data is done via a network based system.

In accordance with another aspect of the present disclosure, the method includes that precise location data includes a timestamp.

In accordance with another aspect of the present disclosure, the method includes that the precise location data includes a mobile identification number.

In accordance with another aspect of the present disclosure, the method includes generating a map reflecting the distribution of the data.

In accordance with yet another aspect of the present disclosure, a system for identifying areas within a cell that insufficient radio frequency coverage includes a data collection module adapted to collect data of a radio frequency representing the positioning of a mobile unit at a given time in response to a trigger where the data includes location information and a post processing module configured to record and store the data and organize the data into a report.

In accordance with another aspect of the present disclosure, the system includes an associated mobile unit which has a global positioning system which used in order to derive the location information.

In accordance with another aspect of the present disclosure, the system includes a location module which is configured to derive the location information from the associate mobile unit's positioning at the given time.

In accordance with another aspect of the present disclosure, the system includes a map generation module.

In accordance with another aspect of the present disclosure, a method that identifies areas within a cell that have poor radio frequency coverage using a trigger response system comprises setting up a mobile call, measuring the radio frequency of the signal emitted from a signal source associated with the call, recording the signal source location in response to an event and storing the time of the event and the signal source location at the time of the event into a database.

In accordance with another aspect of the present disclosure, the method includes generating a map based on the signal source location.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communications network including mobile units, a network provider, a post processing module, a data collection module and a printer;

FIG. 2 is a flow chart illustrating one embodiment of the method according to the present disclosure;

FIG. 3 illustrates a ladder diagram illustrating one embodiment of the present disclosure; and

FIG. 4 is a ladder diagram illustrating interaction between the wireless network and mobile units according to another embodiment of the method according to the present disclosure.

FIG. 5 is a ladder diagram illustrating the interaction between the data collection module and the post processing module in accordance with the steps of the method according to the present disclosure.

### DETAILED DESCRIPTION

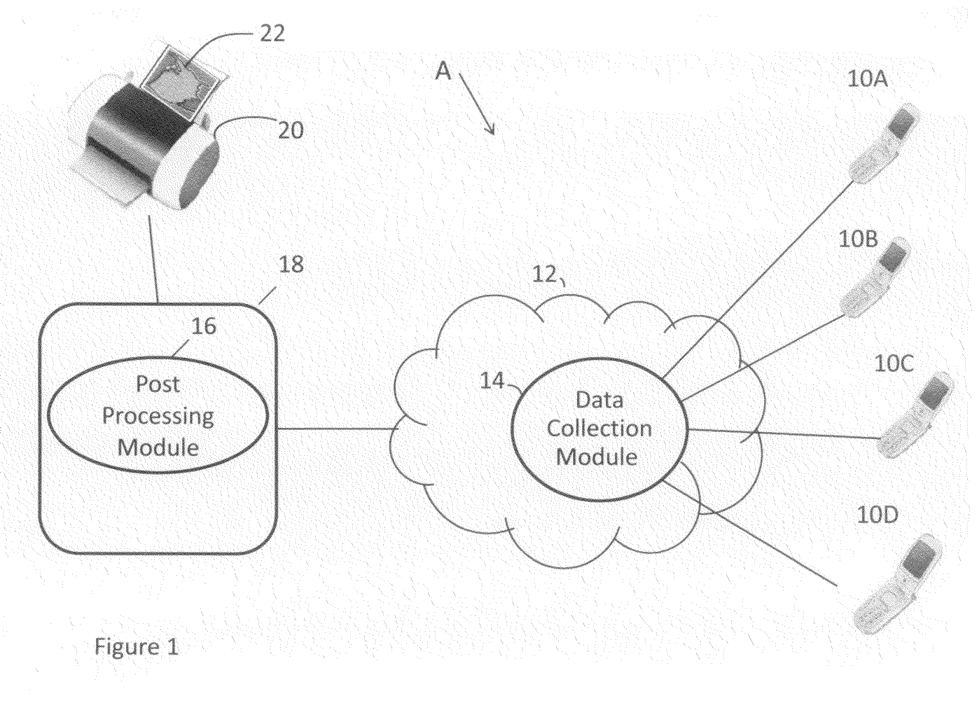

Referring now to the drawings wherein the showings are for purposes of illustrating the disclosed embodiments only and not for purposes of limiting the claimed subject matter, FIG. 1 provides an overall view of a system into which the presently described embodiments may be incorporated. The communications infrastructure A is shown. The communications infrastructure A includes a plurality of mobile units, 10A, 10B, 10C, 10D, a network provider 12, and a data collection module 14. The communications infrastructure A also includes a post processing network element 18, a post processing module 16, a coverage map printer 20 and a coverage map 22. It should be understood that this represents but one embodiment of the communications network infrastructure. The present disclosure could be incorporated in a variety of communication network configurations.

In operation, as described in greater detail below, the presently described embodiments are directed towards a method for identifying areas within a cell that have poor radio frequency coverage. This method leverages the possibility that some mobile units may have positioning systems already in place. However, for those mobile units that do not, methods are used through the network in order to define the precise location of the mobile units in question. These mobile units' RF signals are measured in response to a trigger. The trigger may include a variety of events, including, but not limited to, a timer expiring, a mobile power increase, a weak signal and/or a dropped call. This location information that is gathered from the mobile units is processed and used to create a map. A network administrator may gather this information and use it in order to correct areas with poor coverage. The solution may include building a new cell tower, thereby effectively creating more cells in a highly congested traffic area or an area that would otherwise have poor RF coverage.

Still referring to FIG. 1, a communications infrastructure A is provided. The communications infrastructure A includes a plurality of mobile units 10A, 10B, 10C, 10D, which are in communication with a network provider 12. The network provider 12 includes a data collection module 14. The network provider 12 is also in communication with a post processing network element 18. The post processing network element 18 includes a post processing module 16. The post processing network element 18 is also in communication with a coverage map printer 20. The coverage map printer 20 is capable of printing a coverage map 22. Again, this is but one embodiment of a communications network and a variety of other communications networks may be used in order to implement this disclosure.

Continuing on with FIG. 1, this embodiment shows a plurality of mobile units, 10A, 10B, 10C, and 10D. These mobile units are shown as cellular phones. However, other user equipment besides cellular phones, may be used to communicate with the network provider 12. For example, the mobile units could include a desktop computer, a PDA device, a land line telephone, a Voice over Internet Protocol (VoIP) telephone, etc. Generally, any device that has access to the internet, a web server or the Public Switched Telephone Network (PSTN) may be substituted throughout this disclosure.

The network provider 12 includes a data collection module 14. The network provider allows a mobile unit 10A-10D, access to the public network. The network provider 12 will generally be used to set up the mobile phone call from the mobile unit 10A-10D, while the data collection module 14 is used to collect data from that call. The data stems from the radio frequency and represents the positioning of the mobile unit 10A-10D at a given time. The data includes location information and the given time when data is collected. This given time is generally related to a trigger.

A variety of events may constitute a trigger which prompts the data collection module 14 collects data. A trigger may include a timer expiring. In this form, a timer may be used so that data is collected at regular intervals. A timer may also be used in order to trigger the collection of data during peak times of usage. Furthermore, a timer may be used during low times of usage, or during particular days of the week.

A mobile power increase may also be used as a trigger. Oftentimes, a mobile will increase its power when the signal is fading or getting weaker. This method is used by many mobile units 10A-10D in order to keep the Quality of Service (QoS) at an acceptable level. A weak signal is also one form of a trigger. In this sense, whenever the signal gets weak, due to poor reception, the data may be collected in order to gather a general area where mobile units 10A-10D signals area weak. Another form of a trigger may be a dropped call. Whereas, data may be collected at places where a call has been dropped. Generally, when a dropped call is the trigger, it may be useful to reestablish the connection in order to read and collect the data. The trigger may also be manually activated

Generally, the data will include location information. Location information may be gathered via the mobile unit's 10A-10B Global Positioning System (GPS). However, some mobile units 10A-10D are not GPS capable. In this form, the network provider 12 may rely on other methods in order to collect location information. These methods may include triangulation, or any other method known in the art.

The data received is forwarded to a post processing network element 18 which includes a post processing module 16. The post processing module is configured to record and store the data and organize into a report. This report will allow a network administrator to know where mobile units 10A-10B are located during the time that the trigger was activated. This information may be sent to a printer 20 which in turn is configured to produce a map 22 containing the data which was collected.

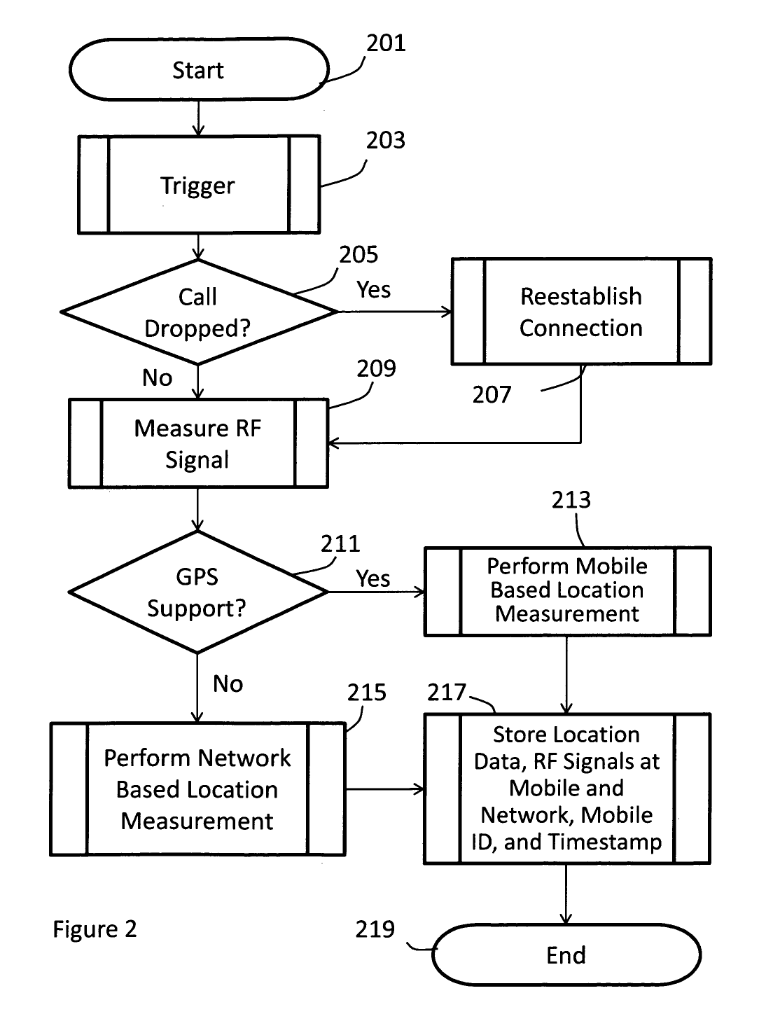

Now referring to FIG. 2, a flow chart illustrating one of the embodiments of the method according to the present disclosure is shown. The method begins with the trigger (at step 203). The trigger may be a variety of events, depending on the implementation of the present disclosure. In one form, a trigger may be a timer expiring. In another form, the trigger is a mobile power increase signaling a reduction in signal strength. In another form, the trigger is a dropped call. In any form, the trigger creates a response that begins the disclosed method.

The method will continue in this embodiment, depending on whether the call is dropped (at step 205). If the call is dropped, a connection is reestablished (at step 207). In some embodiments, the mobile unit 10A-10D has lost the connection with the network provider 12. In this circumstance, in order for the RF signal to be measured, a connection may need to be reestablished. In other embodiments, a dropped call is the trigger itself. In other embodiments, a weak signal may prompt the method to begin, in which case the method may continue (at step 209) with measuring the RF signal through methods known in the art.

The RF signal measurement may include different types of information. In some embodiments the measurement will read the mobile identification number. In other embodiment the measurement includes the trigger that initiated the measurement. In any form, this data is collected in the data collection module 14.

The method continues depending on whether the mobile unit 10A-10D is capable of GPS tracking (at step 211). If the mobile unit 10A-10D has GPS support capabilities the method will continue with performing mobile based location measurement (at step 213). Mobile unit location measurement can be performed through methods known in the art. Mobile tracking is an option available in some mobile units 10A-10D. In this case, the data that is sent to the network provider 12 includes location information.

There also exists many mobile units 10A-10D which are not capable of GPS support. In this scenario, the location measurement may be network based. Therefore, the method continues (at step 215) with performing network based location measurement if there is no GPS support. Network based location measurement may be done through many methods known in the art, including triangulation, E911, etc.

The method continues with storing location data, RF signals at the mobile and the network, mobile ID, and timestamp (at step 217). The data that was gathered from the previous steps may be stored at the post processing module 16. This stored data may be used in a variety of methods, including creating a map based on the location information. This map may be used in order to locate areas with poor RF signaling capabilities. This information may also be used in order to locate geographical locations where there is high traffic density. A network administrator may use this information in order to decide where future cell towers should be placed.

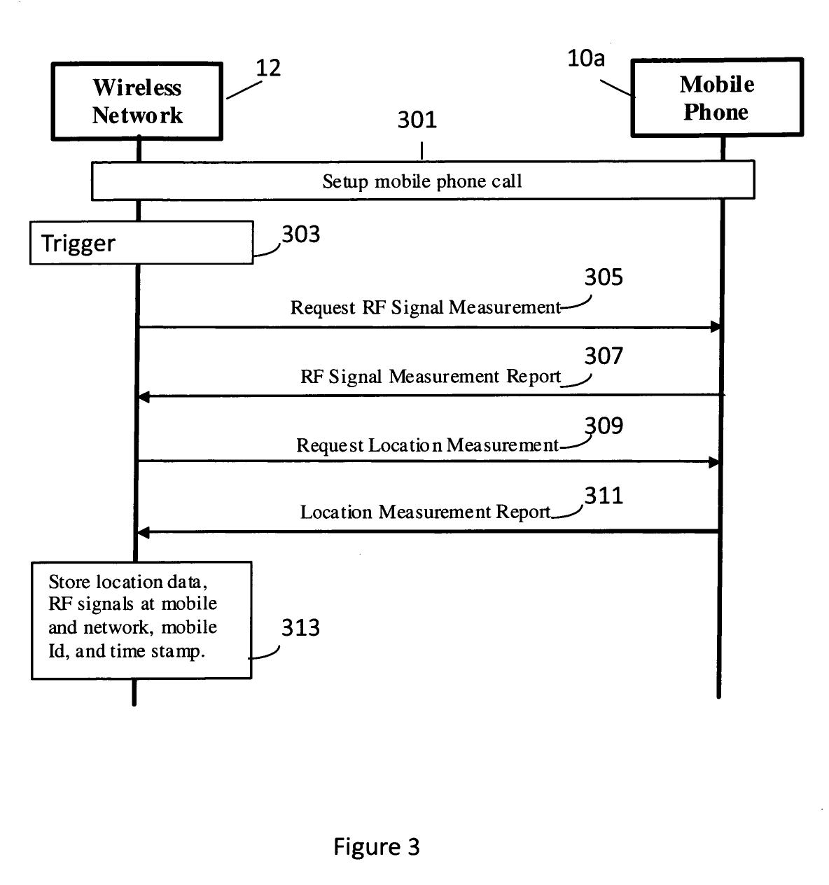

Now referring to FIG. 3, a ladder diagram displaying wireless network and mobile phone interactions is provided. In this embodiment, the mobile phone 10A is GPS capable. The method begins with setting up a mobile phone call (at step 301). The wireless network 12 creates a connection with the mobile phone 10A.

The method continues with a trigger taking place (at step 303). The trigger is an event which prompts a request for RF signal measurement (at step 305). The wireless network 12 sends a list of cells in the RF signal measurement request to the mobile phone 10A. The mobile phone 10A measures the RF signal level from all cells on the list and sends the measurements back to the wireless network 12 (at step 307). The network measures RF signal levels from the mobile phone 10A at multiple cells.

The wireless network 12 will also request a location measurement (at step 309). Mobile phone 10A will, in response, send a location measurement report (at step 311). In this embodiment, mobile phone 10A is capable of creating a location measurement report because of a system located internally in mobile phone 10A.

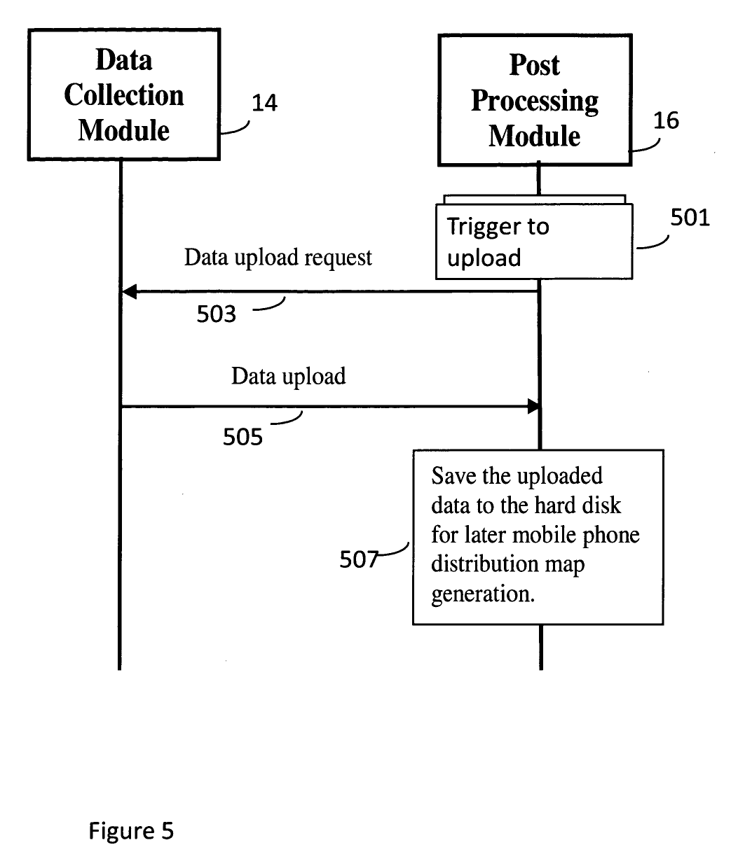

This location information is stored in wireless network 12 (at step 313). This information may include a mobile identification number, a timestamp, etc. This information may also be used in order to generate a report showing the coverage area network problems. This report may also be used to create a map which a network administrator may use in order to determine geographic areas where signal strengths are poor. This process is further detailed in FIG. 5.

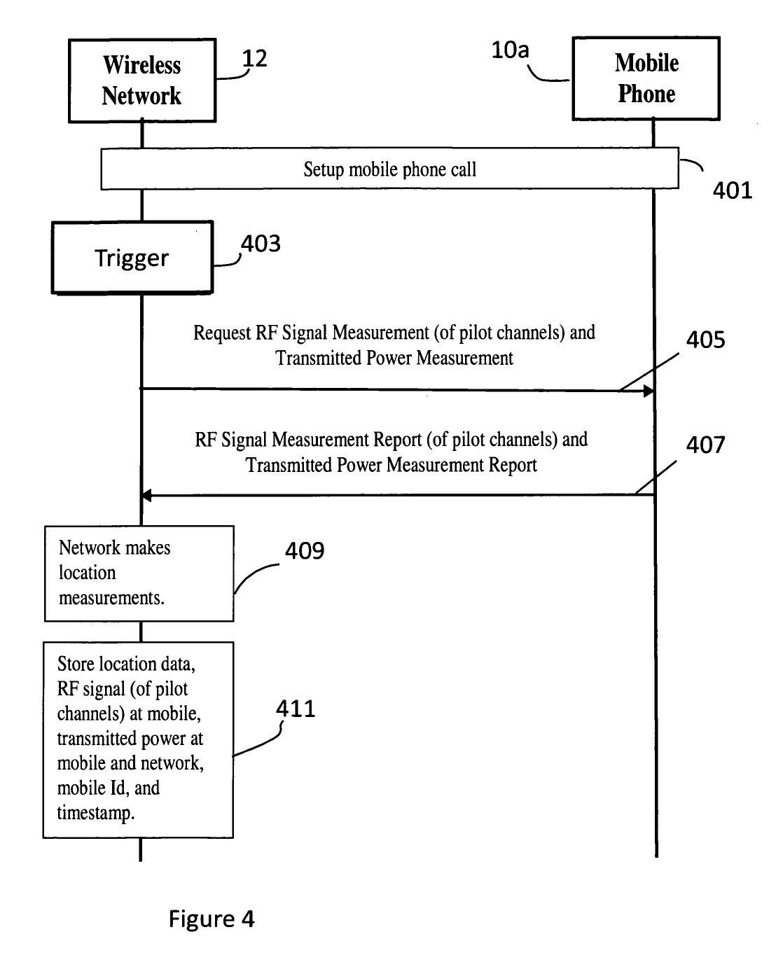

Now referring to FIG. 4, a ladder diagram for a CDMA based wireless network and mobile phone interactions where the mobile phone 10A is not GPS capable is provided. Again, the method begins with setting up the mobile phone call (at step 401).

The method continues (at step 403) with a triggering event. This triggered event may include a timer expiring, a weak signal, a dropped call, or a mobile power increase, among other triggers. Many Code Division Multiple Access (CDMA) based wireless network systems compensate changes in RF signal level by changing transmitted power levels at both the wireless network 12 and the mobile phone 10A. Therefore, CDMA based systems may measure transmitted power level instead of received RF signal level. However, this need not always be the case. An exception is pilot channel, which is transmitted from wireless network at a constant power level. In this form, a more appropriate trigger may be the signal level transmitted by the mobile phone 10A or wireless network 12.

The method continues with an RF signal measurement request (of pilot channels) and transmitted power measurement (at step 405) from the wireless network 12 to the mobile phone 10A. The method continues with a report of the RF signal measurement being sent from the mobile phone 10A to the wireless network 12 (at step 407).

At this point, the wireless network 12 makes the location measurements (at step 409) in this embodiment. The network location measurements may be taken through a variety of means known in the art. The location measurement, along with the RF signal of pilot channels at the mobile 10A, mobile identification number and a timestamp are stored (at step 411) through the wireless network 12.

Now referring to FIG. 5, a ladder diagram demonstrating the post processing modules interaction with the data collection module is provided. The post processing module 16 periodically uploads the data collected by the data collection module 14 as shown. The periodicity of the data upload may be configured by an operator of the wireless network 12. The method begins with a trigger to upload (at step 501). The trigger to upload may be different or similar to the trigger for data collection. In one form, the trigger is periodic at regular intervals. In another form, the trigger is manually operated at the request of an administrator.

The method continues with a data upload request being sent from the post processing module 16 to the data collection module 14 (at step 503). In turn, the data collection module 14 allows the data to be uploaded to the post processing module 16 (at step 505). Once the data is uploaded it is saved to a disk for mobile phone distribution map generation (at step 507). This data may then be sent to a printer 20 in order to create a map 22 to be used by an administrator. The data could also be saved and combined with previous uploaded data. In this form, the data may be manipulated and sorted in a variety of manners. In one embodiment, a map may be generated according to the trigger which initiated data collection. In another form, the data may be sorted according to the time of day of the time stamp. In yet another embodiment, the data may be sorted in relation to a particular set of mobile identification numbers.

The above described embodiments that were shown in FIGS. 2-6 present but a few embodiments of the above-described disclosure. Implementation of the various network elements and steps that they performed depend on how the system is used. These functions may be performed by some or all of the various network elements in conjunction or separate from one another. Variations of these functions may also exist. Description of the embodiments is not meant to limit the claims but instead show how some of the embodiments of the method are used.

Therefore, the above description merely provides a disclosure of the particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method for identifying areas within a cell that have poor radio frequency coverage comprising:
measuring a radio frequency signal of a mobile unit in response to a trigger;
mapping the precise location data of said radio frequency representing the positioning of said mobile unit at a given time, where said given time is related to said trigger;
recording said precise location data for said mobile unit; and
storing said precise location data in a database.

2. The method according to claim 1, wherein said trigger is a timer expiring.

3. The method according to claim 1, wherein said trigger is a mobile power increase.

4. The method according to claim 1, wherein said trigger is a weak signal.

5. The method according to claim 1, wherein said trigger is a dropped call.

6. The method according to claim 5, further comprising reestablishing a connection.

7. The method according to claim 1, wherein mapping said precise location data is done via said mobile unit's global positioning system.

8. The method according to claim 1, wherein mapping said precise location data is done via a network based system.

9. The method according to claim 1, wherein said precise location data includes a timestamp.

10. The method according to claim 1, wherein said precise location data includes a mobile identification number.

11. The method according to claim 1, further comprising generating a map reflecting distribution of said precise location data.

12. A system that identifies areas within a cell that have insufficient radio frequency coverage which leads to poor quality of service comprising:
a data collection module adapted to collect data of a radio frequency representing the positioning of a mobile unit at a given time in response to trigger, where said data includes location information; and
a post processing module configured to record and store said data and organize said data into a report.

13. The system according to claim 12, wherein said associated mobile unit includes a global positioning system which is used to derive said location information.

14. The system according to claim 12, further comprising a location module which is configured to derive said location information from said associated mobile unit's positioning at said given time.

15. The system according to claim 12, further comprising a map generation module.

16. A method that identifies areas within a cell that have poor radio frequency coverage using a trigger response system comprising:
setting up a mobile call;
measuring the radio frequency of the signal emitted from a signal source associated with said call;
recording said signal source location in response to an event; and
storing the time of event and said signal source location at the time of said event into a database.

17. The method according to claim 16, further comprising generating a map based on said signal location.

18. The method according to claim 16, wherein said event is a dropped call.

19. The method according to claim 16, wherein said event is an increase in power usage from said signal source.

20. The method according to claim 16, wherein said event is the expiration of a timer.
